(19) United States
(12) Patent Application Publication
(10) Pub. No.: US 2014/0089878 A1
(43) Pub. Date: Mar. 27, 2014

(54) DETERMINING APPARATUS, DETERMINING METHOD, AND COMPUTER PRODUCT

(71) Applicant: FUJITSU LIMITED, Kawasaki-shi (JP)

(72) Inventors: Hidaka KUROKAWA, Kawasaki (JP); Naomi ISOMURA, Suginami (JP)

(73) Assignee: FUJITSU LIMITED, Kawasaki-shi (JP)

(21) Appl. No.: 14/031,241

(22) Filed: Sep. 19, 2013

(30) Foreign Application Priority Data
Sep. 21, 2012 (JP) 2012-208982

(51) Int. Cl. G06F 17/50

(52) U.S. Cl. CPC G06F 17/5081
USPC 716/112

(57) ABSTRACT

A determining apparatus includes a processor configured to detect from among a group of sectional areas obtained by dividing layout data indicating a design area concerning a circuit-under-design and stored in a storage device, adjacent sectional areas that are adjacent to sectional areas in a design change area and outside the design change area; count with respect to the sectional areas that are outside the design change area and among the group of sectional areas, number of detections as the adjacent sectional area; judge whether the number of detections counted is at least a predetermined number of two; and determine as an area for extraction for wiring parasitic capacitance, the sectional areas for which the number of detections is judged to be at least the predetermined number.

### CROSS REFERENCE TO RELATED APPLICATIONS

This application is based upon and claims the benefit of priority of the prior Japanese Patent Application No. 2012-208982, filed on Sep. 21, 2012, the entire contents of which are incorporated herein by reference.

### FIELD

The embodiment discussed herein is related to a determining apparatus, a determining method, and a computer product.

### BACKGROUND

In timing analysis executed in the design of large scale integration (LSI), extraction of wiring parasitic capacitance (hereinafter, referred to as “RC extraction”) is necessary. The RC extraction is executed taking into consideration the effects of mounting information in terms of the cells, via holes, and wires disposed on a chip as well as the respective positions thereof. When the timing analysis results in a change made to the design, the RC extraction needs to be executed again for the mounting information according to the change in the design.

Recently, the scale of design has increased and the volume of mounting information has also increased accordingly. Consequently, the time period necessary for the RC extraction occupies a greater portion of the timing analysis. At current design scales, when RC extraction is repeatedly executed, the turn around time (TAT) is degraded and the designing becomes unpractical. Therefore, according to a disclosed technique, when a portion of the layout is changed at the layout design stage, RC extraction is executed for the area relating to the changed portion (see, e.g., Japanese Laid-Open Patent Publication Nos. 2009-271607 and H8-320888).

However, in current design environments where the LSI fabrication becomes finer and the mounting density drastically increases, design changes need to be made to various portions of the LSI. Therefore, according to the conventional techniques, it is difficult to properly determine the area for the RC extraction if the layout is changed. For example, if the RC extraction area is too large, the amount of memory used becomes large. Therefore, a problem arises in that the time period necessary for the analysis increases. If the RC extraction area is limited, another problem arises in that the accuracy of the RC extraction drops.

### SUMMARY

According to an aspect of an embodiment, a determining apparatus includes a processor configured to detect from among a group of sectional areas obtained by dividing layout data indicating a design area concerning a circuit-under-design and stored in a storage device, adjacent sectional areas that are adjacent to sectional areas in a design change area and outside the design change area; count with respect to the sectional areas that are outside the design change area and among the group of sectional areas, number of detections as the adjacent sectional area; judge whether the number of detections counted is at least a predetermined number of two; and determine as an area for extraction for wiring parasitic capacitance, the sectional areas for which the number of detections is judged to be at least the predetermined number.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of determination of an RC extraction area;

FIG. 2 is a block diagram of an example of a hardware configuration of a determining apparatus;

FIG. 3 is a block diagram of an example of a functional configuration of a determining apparatus 200;

FIG. 4 is an explanatory diagram of an example of the data structure of design area information;

FIG. 5 is an explanatory diagram of an example of the data structure of sectional area information;

FIG. 6 is an explanatory diagram of a design change area in layout data 100;

FIG. 7 is an explanatory diagram of a correction area 1 acquired by determination by a determining unit 307;

FIG. 8 is an explanatory diagram (Part I) of sectional areas that are determined as a correction area 2;

FIG. 9 is an explanatory diagram (Part II) of sectional areas that are determined as the correction area 2;

FIG. 10 is an explanatory diagram (Part III) of sectional areas that are determined as the correction area 2;

FIG. 11 is an explanatory diagram (Part IV) of sectional areas that are determined as the correction area 2;

FIG. 12 is an explanatory diagram (Part V) of sectional areas that are determined as the correction area 2;

FIG. 13 is an explanatory diagram (Part VI) of sectional areas that are determined as the correction area 2;

FIG. 14 is an explanatory diagram of an example of an RC extraction area;

FIG. 15 is an explanatory diagram of an example where information unrelated to the RC extraction area is deleted;

FIG. 16 is an explanatory diagram of the state after translation of the RC extraction area by a changing unit 309;

FIG. 17 is an explanatory diagram of a virtual hierarchy to be the RC extraction area acquired after translation;

FIG. 18 is a flowchart of an example of a procedure of a determining process for determining the RC extraction area and executed by the determining apparatus 200;

FIG. 19 is a flowchart of an example of a detailed procedure of an updating process (step S1802) depicted in FIG. 18;

FIG. 20 is a flowchart of an example of a detailed process procedure of a correction area 1 setting process (step S1803) depicted in FIG. 18;

FIG. 21 is a flowchart (Part I) of an example of a detailed process procedure of a correction area 2 setting process (step S1804) depicted in FIG. 18;

FIG. 22 is a flowchart (Part II) of an example of a detailed process procedure of a correction area 2 setting process (step S1804) depicted in FIG. 18;

FIG. 23 is a flowchart of an example of a detailed process procedure of a correction area 3 setting process (step S1805) depicted in FIG. 18;

FIG. 24 is a flowchart of an example of a detailed process procedure of an extraction process (step S1806) depicted in FIG. 18; and

FIGS. 25A and 25B are explanatory diagrams of examples of an input and output screen on the determining apparatus 200 according to the embodiment.

### DESCRIPTION OF EMBODIMENTS

Preferred embodiments of a determining apparatus, a determining method, and a computer product will be described with reference to the accompanying drawings.

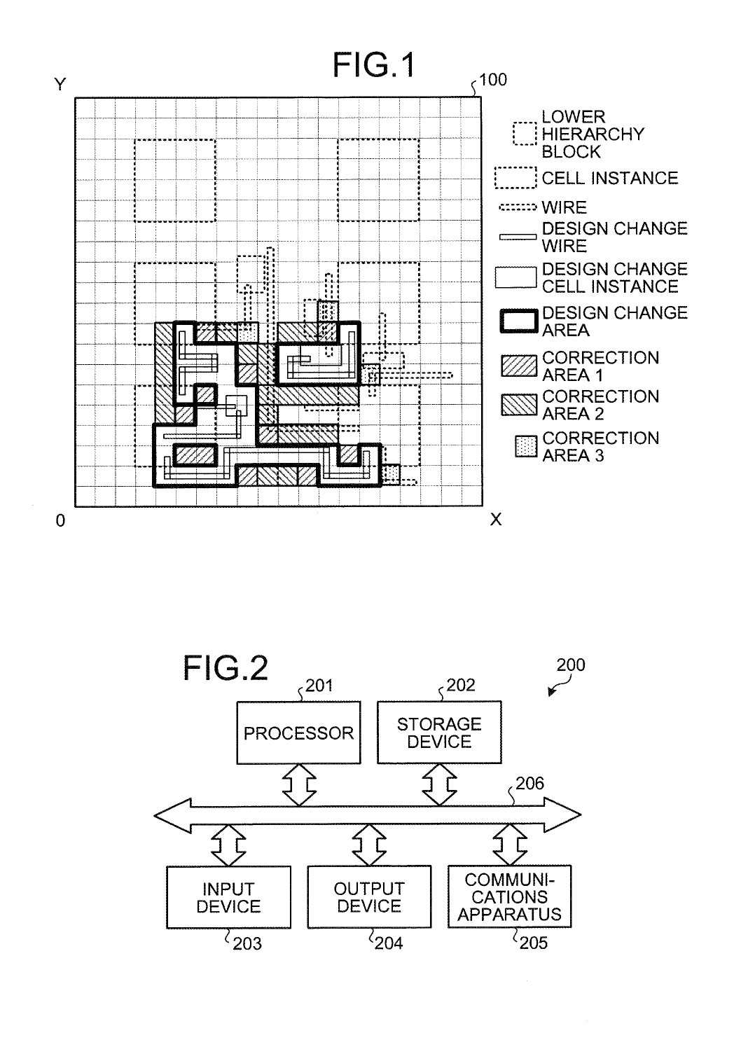

FIG. 1 is an explanatory diagram of an example of determination of an RC extraction area. An “RC extraction area” is a set of sectional areas respectively for extracting wiring parasitic capacitance. Layout data 100 of a circuit-under-design is divided into a grid. The lower-left vertex of the layout data 100 is the origin, the axis of abscissa is the X-axis, and the axis of ordinate is the Y-axis.

Each of block resulting from dividing the layout data 100 into a grid is referred to as a “sectional area”. The sectional areas collectively form the design area. Cell instances and wiring are indicated in the layout data 100. If a timing restriction is not satisfied as a result of the execution of the timing analysis using the layout data 100, the design engineer makes design changes with respect to the mounted components such as the cell instances and the wires. A “design-changed cell instance” and a “design-changed wire” are mounted components after the design change. A group of sectional areas that include the mounted components after the design change is a design change area. The design change area is an RC extraction area. A sectional area in which a mounted component before the design change is present and a sectional area in which a lower hierarchy block is present are not included in the RC extraction area.

A sectional area located in a vicinity of the design change area may be included in the RC extraction area. If a group of sectional areas on the outer perimeter of the design change area is included in the RC extraction area, the amount of memory used increases and the processing time period increases compared to a case where the group of sectional areas on the outer perimeter is not included. On the other hand, the accuracy of the RC extraction drops if the group of sectional areas on the outer perimeter is not included at all. In the embodiment, the least number of necessary sectional areas that do not reduce the accuracy of the RC extraction and that are outside the design change area are determined as the RC extraction area and thereby, a reduction of the processing time period of the RC extraction is facilitated within a range that the accuracy necessary for the timing analysis can be maintained.

In FIG. 1, a correction area 1 is an area that is identified by taking into consideration the degree of concentration of the design change areas. A correction area 1 is a set of sectional areas among the sectional areas outside the design change area and respectively surrounded by the design change area at two or more sides; and is included in the RC extraction area. In this manner, surrounding sectional areas are an RC extraction area depending on the number of sides of the sectional areas in contact with a design change area. For example, a sectional area surrounded by a design change area at two or more sides is included in the correction area 1 while a sectional area surrounded by the design change area at one or no sides is not included in the correction area 1. Thus, increases in the RC extraction area can be suppressed and the accuracy of the RC extraction can be improved.

A correction area 2 is an area that is identified by taking into consideration the degree of concentration of the design change areas; and is a set of sectional areas of three types as follows.

1) A sectional area that is among the sectional areas not included in the design change area and the correction area 1, and has one side adjacent to the design change area and another one side adjacent to the correction area 1;
2) A sectional area that is among the sectional areas other than the sectional areas in the design change area, the correction area 1, and 1) above, and that is adjacent to a sectional area identified in 1) above and that is adjacent to the design change area; and
3) A sectional area that is among the sectional areas other than the sectional areas in the design change area, the correction area 1, the sectional areas of 1) above, and the sectional areas of 2) above, adjacent to a sectional area identified in 2) above, and that is adjacent to the design change area.

A correction area 3 is an area that is identified by taking into consideration the wiring density and the wire width in a sectional area adjacent to a correction area 3. The “correction area 3” is a set of sectional areas formed by expanding the RC extraction area by N areas in a direction perpendicular to the side adjacent to a neighboring sectional area, according to the mounting state of the wires in the sectional area adjacent to the RC extraction area that includes the correction areas 1 and 2. The variable N is acquired from Eq. (1) below to take into consideration the wiring density and the width of the wire in the sectional area. In Eq. (1), the total area of the mounted wires is “Wa”, the area of the floor is “Fa”, and a coefficient received from a user is “β”. The coefficient “β” used herein is a real number whose initial value is one and that is zero or greater. Setting β to be a value greater than or equal to one enables the areas included in the correction area 3 to be increased.

N=β(Wa/Fa) (1)

The identification of the correction area 3 enables the accuracy of the RC extraction to be improved and suppresses expansion of the RC extraction area, while taking into consideration the wiring density and the wire width in the sectional areas that are unknown based only on the degree of the concentration in the design change area taken into consideration for the correction areas 1 and 2.

FIG. 2 is a block diagram of an example of the hardware configuration of the determining apparatus. In FIG. 2, the determining apparatus 200 includes a processor 201, a storage device 202, an input device 203, an output device 204, and a communications apparatus 205 that are connected by a bus 206 to each other.

The processor 201 supervises the control of the determining apparatus 200 overall. The processor 201 executes various programs (operating systems (OSs) and the determination program of the embodiment) stored in the storage device 202 and thereby, reads data in the storage device 202 and writes data that is the execution result into the storage device 202.

The storage device 202 includes read only memory (ROM), random access memory (RAM), flash memory, a magnetic disk drive, etc.; acts as a work area for the processor 201; stores the various programs (the OSs and a display control program of the embodiment) and various types of data (including data acquired by executing the programs); etc.

The input device 203 is an interface that executes the input of various types of data by user operation via a keyboard, a mouse, a touch panel, etc. The output device 204 is an interface that outputs data according to an instruction of the processor 201. The output device 204 can be display or print out at a printer. The communications apparatus 205 is an interface that receives data from an external source through a network and that transmits data through the network to an external destination.

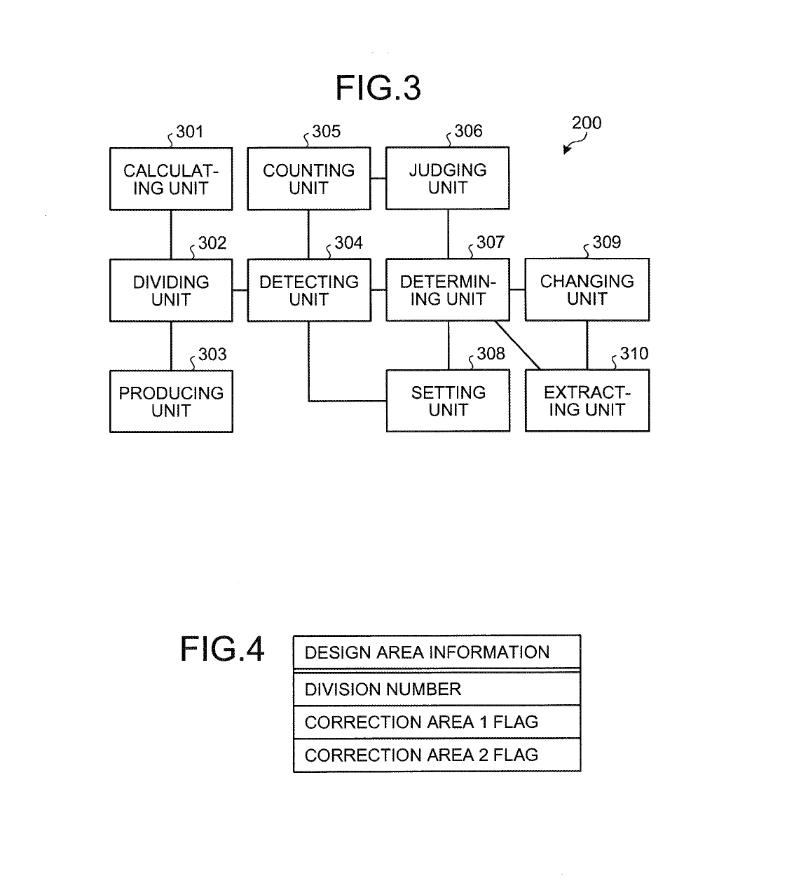

FIG. 3 is a block diagram of an example of a functional configuration of the determining apparatus 200. The determining apparatus 200 includes a calculating unit 301, a dividing unit 302, a producing unit 303, a detecting unit 304, a counting unit 305, a judging unit 306, a determining unit 307, a setting unit 308, a changing unit 309, and an extracting unit 310. Functions of the units from the calculating unit 301 to the extracting unit 310 are implemented by, for example, causing the processor 201 to execute the programs stored in the storage device 202 depicted in FIG. 2.

The calculating unit 301 calculates the division number of the design area based on the area of the mounted components to be mounted in the design area. The “mounted components to be mounted in the design area” refer to the cells and wires that are disposed and wired in the layout data 100. The “division number” is the total number of the sectional areas. The area of one sectional area becomes smaller as the division number increases and therefore, the RC extraction area can be designated more precisely. However, as described later, each sectional area retains sectional area information that is used to manage the sectional area and therefore, the greater the division number is, of the greater the volume of the sectional area information is. If the volume of sectional area information is increases, production of the design area information related to the layout data 100 entirely and the processing of the RC extraction described later each take a long time, and the amount of used memory increases.

Therefore, in setting the division number, it is necessary to take into consideration the balance between the amount of data of each sectional area and the division number. Therefore, it is necessary to employ the data amount per area of the design area, that is, the mounting density, as a criterion. Based on these factors, the calculating unit 301 calculates the division number “A” that determines the size for the division, according to Eq. (2) below.

In Eq. (2), the area of the design area is denoted by “S”; the total areas of the cells, the wires, and the via holes are respectively denoted by “Cα”, “Wa”, and “Va”; and technology coefficients are denoted by “Cα”, “Wβ”, and “Vγ”. A division coefficient “α” is designated by the design engineer, is a real number that is greater than or equal to zero, and has an initial value that is α=1. Setting α to be a value that is greater than or equal to one enables each sectional area to be enlarged.

A=(Cα×Cₐ+Wβ×Wₐ+Vγ×Vₐ)/S (2)

The technology coefficients “Cα”, “Wβ”, and “Vγ” are coefficients that are set to support various technologies because the properties of the cells, the wires, and the via holes result in numerical values that differ depending on the technology used in designing the chip.

For example, the technology coefficient Cα is the technology coefficient of the cells and is proportional to the performance and the number of transistors to be used in the cell to be designed. In general, when a comparison is executed between cells that are designed using the same technology, the degree of integration and power consumption become higher as the speed of the transistors therein becomes higher. On the other hand, the effect on the RC extraction also becomes deeper in proportion to the speed and the degree of integration. Therefore, the division number A is increased or decreased by defining the technology coefficient Cα that is proportional to the performance and the number of the transistors and thereby, the accuracy of the RC extraction can be maintained at a constant level.

The technology coefficient Wβ is the technology coefficient of the wires and is inversely proportional to the wire width. With the advancement of the fine semiconductor design, the wire width is reduced and the wires tend to be affected by the wiring parasitic elements. Therefore, the division number A is increased or decreased by defining the technology coefficient Wβ that is inversely proportional to the wire width and thereby, the accuracy of the RC extraction can be maintained at a constant level.

The technology coefficient Vγ is the technology coefficient of the via holes and is proportional to the number of disposed via holes and the resistance value thereof. With the advancement of the fine semiconductor design, the area of each via hole is reduced. On the other hand, the increase of the layers is advanced for designing a multi-layered LSI and the number of via holes is increased that are used in the designed LSI. In this case, plural types of via holes are used and the resistance value of the via hole significantly differs depending on the type of via hole. Therefore, the number of disposed via holes and the resistance value of each, in addition to the total area of the via holes, are important for the effect of the via hole on the RC extraction. Thus, the division number A is increased or decreased by defining the technology coefficient Vγ that is proportional to the number of disposed via holes and the resistance value of each. Thus, the accuracy of the RC extraction can be maintained at a constant level.

Combinations of the technology coefficients Cα, Wβ, and Vγ are as follows that are examples taken assuming that the type of the cell and the positions thereof for disposition are fixed and those for the wire and the via hole are changed. The combinations of the technology coefficients Cα, Wβ, and Vγ may be stored in advance in the storage device 202 or may be input from the input device by the design engineer.

### Example 1

### Total Area S of Design Area

### S=3,000

Division coefficient: α=1
Total area of cell: 500
Technology coefficient: Cα=60
Wire width: 0.07
Total area of wires: 100
Technology coefficient: Wβ=50
Resistance value of via holes: 200
Number of via holes: 10
Total area of via holes: 10
Technology coefficient: Vγ=100

The division number A in the example 1 is acquired as follows using Eq. (2).

A=1×(60×500+50×100+100×10)/3000=12

### Example 2

### Total Area S of Design Area

S=3,000

Division coefficient: α=1
Total area of cell: 500
Technology coefficient: Cα=60
Wire width: 0.07
Total area of wires: 1000
Technology coefficient: Wβ=60
Resistance value of via holes: 400
Number of via holes: 15
Total area of via holes: 15
Technology coefficient: Vγ=1000

The division number A in the example 2 is acquired as follows using Eq. (2).

A=1×(60×500+60×1000+1200×15)/3000=36

The dividing unit 302 divides the design area based on the division number A calculated by the calculating unit 301. For example, the dividing unit 302 divides the design area such that the number of sectional areas in the X-axis direction and the number of sectional areas in the Y-axis direction are equal. In the example 1 above, the division number A is A=12 and therefore, the dividing unit 302 divides the design area such that the number of sectional areas in the X-axis direction is three (or four) and that in the Y-axis direction is four (or three). In the example 2 above, the division number A is A=36 and therefore, the dividing unit 302 divides the design area such that the number of sectional areas in the X-axis direction is six and that in the Y-axis direction is six.

The producing unit 303 produces the design area information and a group of sectional area information items based on the layout data 100 that is divided based on the division number A.

FIG. 4 is an explanatory diagram of an example of the data structure of the design area information. The design area information stores the division number A, a correction area 1 flag, and a correction area 2 flag. The division number A is written into the design area information when the calculating unit 301 calculates the division number A or when the dividing unit 302 divides the design area based on the division number A.

The correction area 1 flag is a flag that indicates that at least one sectional area of the group of sectional areas become(s) a correction area(s) 1. The correction area 1 flag is set to be “0” in the initial state and is set to be “1” when a sectional area appears that becomes a correction area 1.

The correction area 2 flag is a flag that indicates that at least one sectional area of the group of sectional areas become(s) a correction area(s) 2. The correction area 2 flag is set to be “0” in the initial state and is set to be “1” when a sectional area appears that becomes a correction area 2.

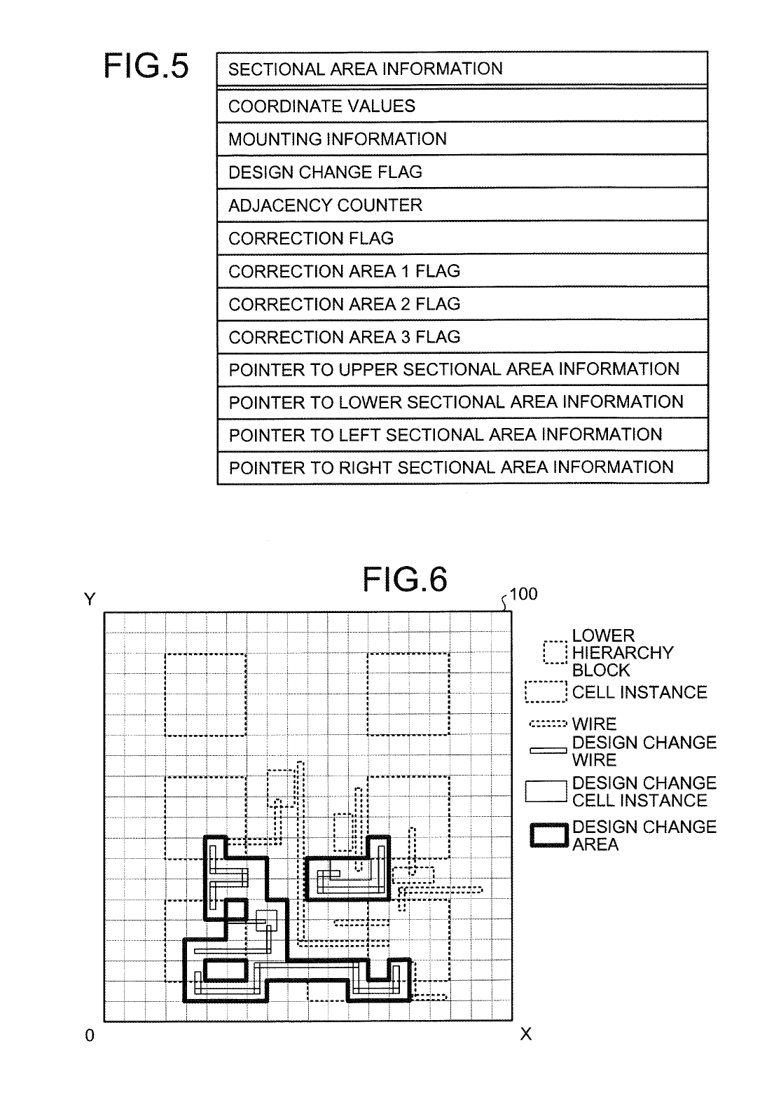

FIG. 5 is an explanatory diagram of an example of the data structure of the sectional area information. The sectional area information stores coordinate values, the mounting information, a design change flag, an adjacency counter, a correction flag, the correction area 1 flag, the correction area 2 flag, a correction area 3 flag, a pointer to upper sectional area information, a pointer to lower sectional area information, a pointer to left sectional area information, and a pointer to right sectional area information. The sectional area information is present for each of the sectional areas.

The coordinate values identify the position of the corresponding sectional area. For example, the coordinate values that represent the upper-right vertex of the corresponding sectional area are used. Therefore, for example, the coordinate values (x, y) of the sectional area having the origin O as a lower-left vertex is (x, y)=(1, 1).

The mounting information is the information that indicates which component is mounted in the corresponding sectional area. For example, the mounting information stores a cell, a wire, a via hole, etc., or may store specific information such as the types of the cell including AND or OR, the width of the wire, and the shape of the via hole.

The design change flag is a flag that indicates whether the corresponding sectional area is included in the design change area. The design change flag is set to be “0” in the initial state and is set to be “1” when the corresponding sectional area overlaps with the design change area.

The adjacency counter is a counter that indicates how many times the corresponding sectional area is adjacent to the design change area. The initial value of the adjacency counter is “0” and the value of the adjacency counter indicates how many sides of the corresponding sectional area are adjacent to the design change area. For example, when the value of the adjacency counter is “1”, this indicates that any one side of the corresponding sectional area is adjacent to the design change area; when the value thereof is “2”, this indicates that any two sides of the corresponding sectional area are adjacent to the design change area; and when the value thereof is “0”, this indicates that no side of the corresponding sectional area is adjacent to the design change area.

The correction flag is a flag that indicates whether the corresponding sectional area is adjacent to a sectional area that is designated to be the correction area 1 or 2. The correction flag is set to be “0” in the initial state and is set to be “1” when the corresponding sectional area is adjacent to a sectional area that is designated to be the correction area 1 or 2.

The correction area 1 flag is a flag that indicates that the corresponding sectional area has become a correction area 1. The correction area 1 flag is set to be “0” in the initial state and is set to be “1” when the corresponding sectional area is designated to be a correction area 1.

The correction area 2 flag is a flag that indicates that the corresponding sectional area has become a correction area 2. The correction area 1 flag is set to be “0” in the initial state and is set to be “1” when the corresponding sectional area is designated to be a correction area 2.

The correction area 3 flag is a flag that indicates that the corresponding sectional area has become a correction area 3. The correction area 1 flag is set to be “0” in the initial state and is set to be “1” when the corresponding sectional area is designated to be a correction area 3.

The pointer to upper sectional area information is information that designates the sectional area information of an upper sectional area adjacent to the upper portion of the corresponding sectional area. The pointer to lower sectional area information is information that designates the sectional area information of a lower sectional area adjacent to the lower portion of the corresponding sectional area. The pointer to left sectional area information is information that designates the sectional area information of a left sectional area adjacent to the left portion of the corresponding sectional area. The pointer to right sectional area information is information that designates the sectional area information of a right sectional area adjacent to the right portion of the corresponding sectional area.

Reference of the description returns to FIG. 3. The detecting unit 304 detects adjacent sectional areas that are outside the design change area and adjacent to the sectional areas in the design change area, from among the group of sectional areas acquired by dividing the design area concerning the circuit-under-design that is stored in the storage device 202. For example, the detecting unit 304 detects, from among the group of sectional areas, the sectional areas that are adjacent to the sectional areas of the design change area and that are present outside the design change area. The design change area will be described in detail.

FIG. 6 is an explanatory diagram of the design change area in the layout data 100. The design change area is a set of the sectional areas that include points whose design is to be changed such as design change wires, design change cell instances, and design change via holes not depicted. The design change area is included in the RC extraction area. The detecting unit 304 detects a set of the sectional areas that include the design change points as the design change area, and detects the sectional areas that are adjacent to the design change area. The sectional areas detected by the detecting unit 304 are each referred to as an “adjacent sectional area”.

Reference of the description returns to FIG. 3. The counting unit 305 counts the number of detections as an adjacent sectional area by the detecting unit 304, with respect to the sectional areas that are outside the design change area and among the group of sectional areas. For example, the counting unit 305 counts the number of detections as the adjacent sectional area by the detecting unit 304 for each sectional area outside the design change area, among the group of sectional areas.

The judging unit 306 judges if the number of detections counted by the counting unit 305 is greater than or equal to two, i.e., a predetermined number. Adjacent sectional areas for which the number of detections is greater than or equal to the predetermined number are designated to be a correction area 1. The predetermined number is set in advance. When the predetermined number is “2”, it is determined whether any two or more sides of each of the adjacent sectional areas are adjacent to the design change area. When the predetermined number is “1”, all the adjacent sectional areas adjacent to the design change area are designated to be a correction area 1, and the number of sectional areas of the correction area 1 increases. Consequently, the amount of memory used increases. Therefore, setting the predetermined number to be two or larger enables the accuracy of the RC extraction to be improved while suppressing increases in the RC extraction area.

The determining unit 307 determines the sectional areas for which it is judged by the judging unit 306 that the number of detections is greater than or equal to the predetermined number, as “areas for extraction” for the wiring parasitic capacitance. For example, the determining unit 307 determines each adjacent sectional area for which it is judged that the number of detections is greater than or equal to the predetermined number, as an area for extraction for the wiring parasitic capacitance. The adjacent sectional areas determined as areas for extraction for the wiring parasitic capacitance are included in the RC extraction area.

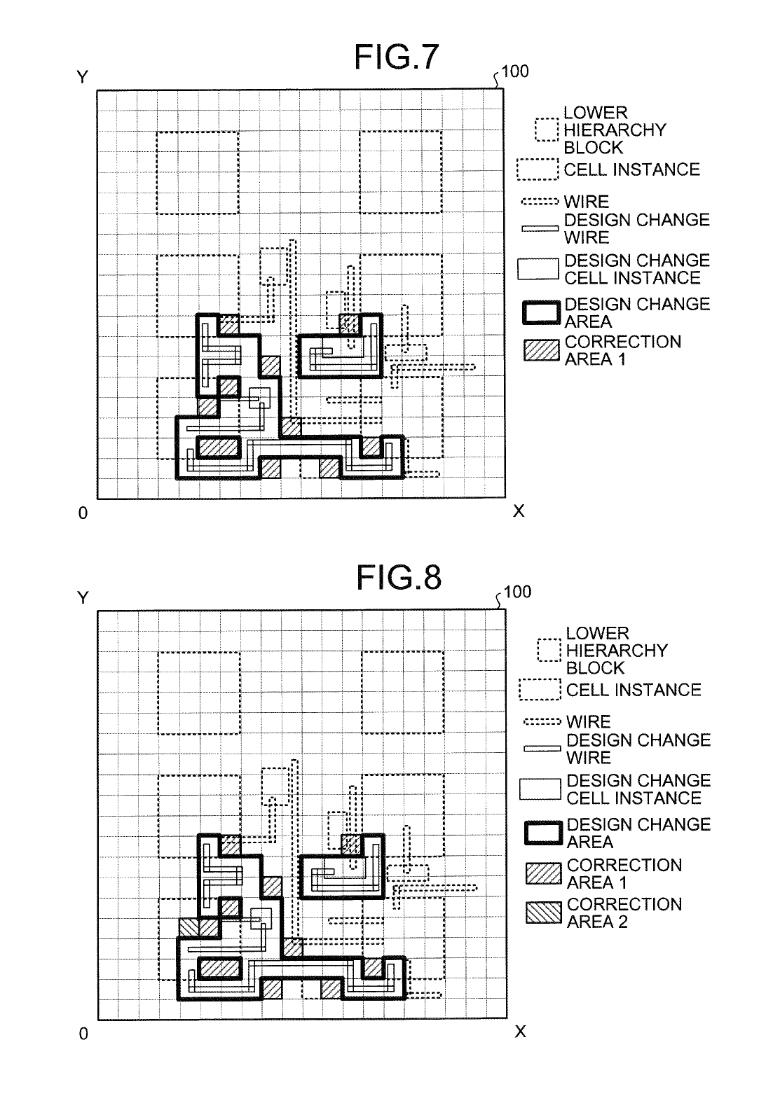

FIG. 7 is an explanatory diagram of the correction area 1 acquired by the determination by the determining unit 307. As depicted in FIG. 7, not all the sectional areas on the outer circumference of the design change area but rather the set of adjacent sectional areas for which the number of detections is greater than or equal to two are the correction area 1, among the adjacent sectional areas. Therefore, setting the predetermined number to be two or larger enables the accuracy of the RC extraction to be improved while suppressing increases of the RC extraction area.

Reference of the description returns to FIG. 3. A determination function (Part I) of the correction area 2 will be described. The detecting unit 304 detects, from the group of sectional areas, the adjacent sectional areas that are each adjacent to the sectional areas in the design change area and the sectional areas determined as the area for extraction (“first area for extraction”) by the determining unit 307, that are not determined as the first area for extraction, and that are outside the design change area. For example, the detecting unit 304 detects, from the group of sectional areas, the sectional areas that are adjacent to the sectional areas in the design change area and the sectional areas determined as the correction area 1, that are not determined as the sectional areas determined as the correction area 1, and that are outside the design change area.

After the determination of the correction area 1, the RC extraction area includes the design change area and the correction area 1. Therefore, the detecting unit 304 detects the sectional areas that are adjacent to both the design change area and the correction area 1 that form the RC extraction area. For example, the sectional areas are detected that are each adjacent to the design change area at one side and the correction area 1 at another one side. The sectional areas already determined as the correction area 1 and the sectional areas in the design change area are excluded from those to be detected.

The determining unit 307 determines the adjacent sectional areas that are detected by the detecting unit 304, that are adjacent to the sectional areas in the design change area and the sectional areas determined as the first area for extraction, that are not determined as the first area for extraction, and that are outside the design change area, as a second area for extraction for the wiring parasitic capacitance. For example, the determining unit 307 determines the sectional areas that are each adjacent to both the design change area and the correction area 1 that form the RC extraction area, as the sectional areas of the correction area 2.

FIG. 8 is an explanatory diagram (Part I) of the sectional areas that are determined as the correction area 2. FIG. 8 depicts the next state of that in FIG. 7, whereby pinpoint designation is enabled for the sectional areas that are not determined as the correction area 1 and that are suitable for being the RC extraction area. Thus, the accuracy of the RC extraction can be improved while suppressing increases in the RC extraction area.

Reference of the description returns to FIG. 3. A determination function (Part II) of the correction area 2 will be described. The detecting unit 304 detects, from the group of sectional areas, the adjacent sectional areas that are each adjacent to the sectional areas in the design change area and the sectional areas determined as the area for extraction (“second area for extraction”) by the determining unit 307, that are not determined as the first area or the second area for extraction, and that are outside the design change area. For example, the detecting unit 304 detects, from the group of sectional areas, the sectional areas that are adjacent to the sectional areas in the design change area and the sectional areas determined as the correction area 2, that are not determined as the sectional areas determined as the correction areas 1 or 2, and that are outside the design change area.

At the determination of the correction area 2, the RC extraction area includes the design change area and the correction areas 1 and 2. Therefore, the detecting unit 304 detects the sectional areas that are adjacent to both the design change area and the correction areas 1 and 2 that form the RC extraction area. For example, the sectional areas are detected that are each adjacent to the design change area at one side, the correction area 1 at another one side, and the correction area 2 at another one side. The sectional areas already determined as the correction areas 1 or 2 and the sectional areas in the design change area are excluded from those to be detected.

The determining unit 307 determines the adjacent sectional areas that are detected by the detecting unit 304, that are adjacent to the sectional areas in the design change area and the sectional areas determined as the second area for extraction, that are not determined as the second area for extraction, and that are outside the design change area, as the second area for extraction for the wiring parasitic capacitance. For example, the determining unit 307 determines the sectional areas that are each adjacent to both the design change area and the correction area 2 that form the RC extraction area, as the sectional areas of the correction area 2.

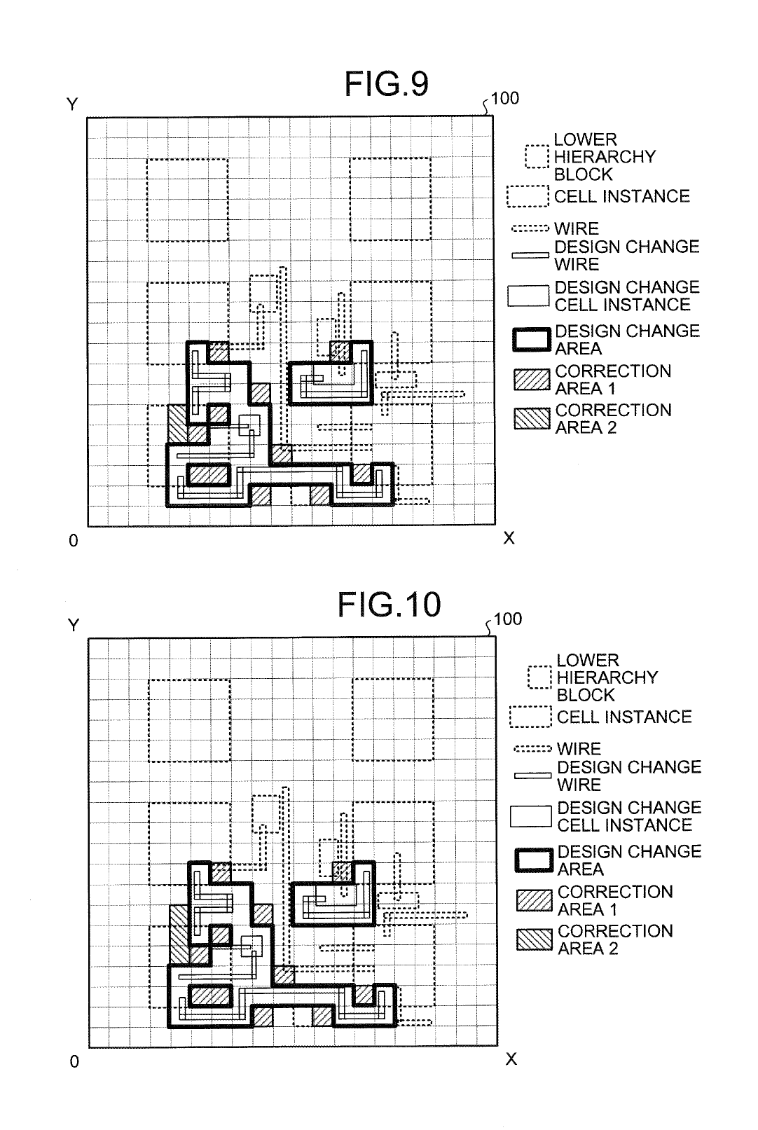

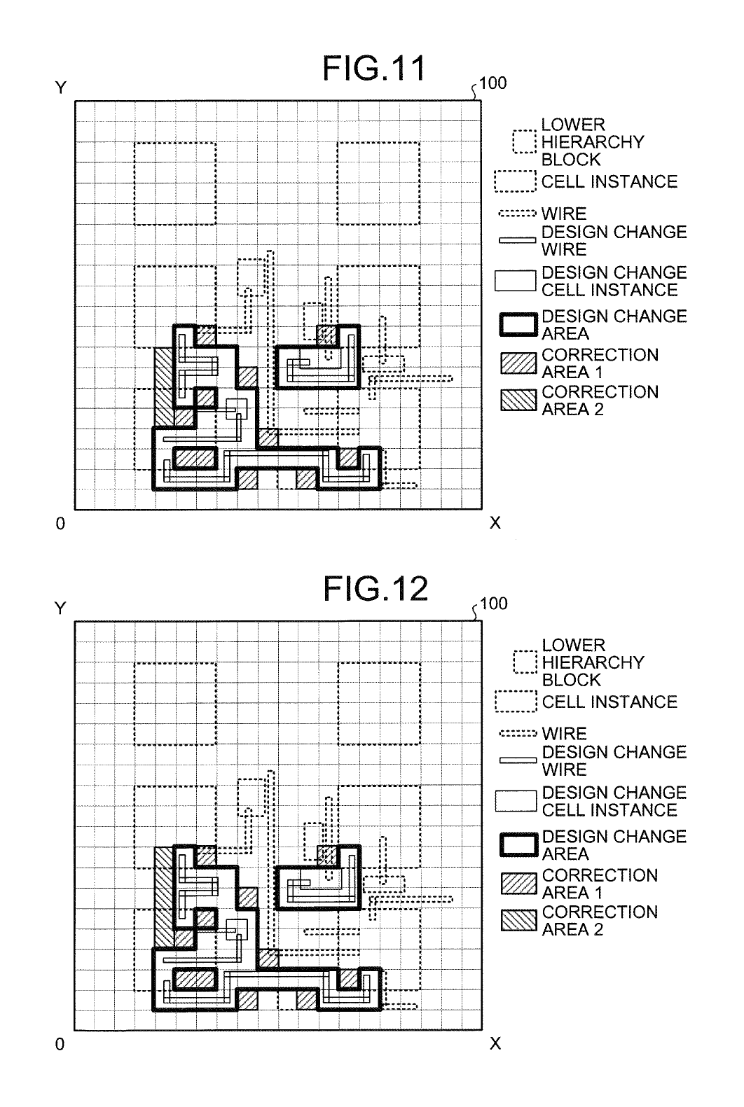

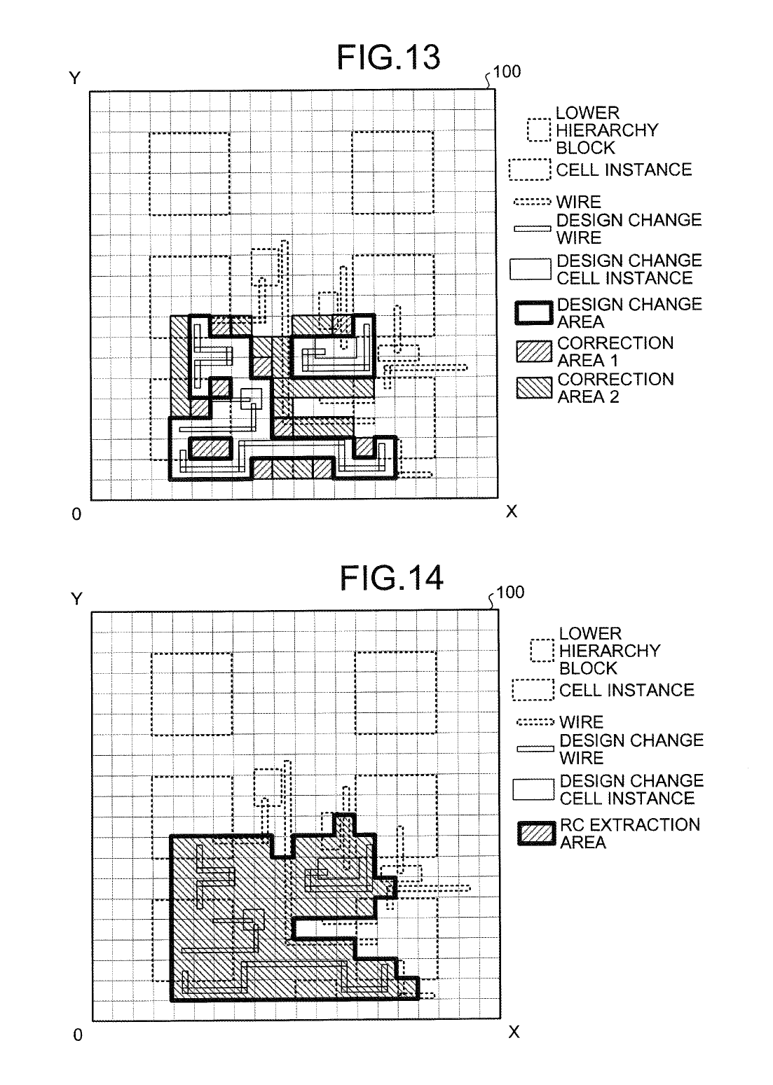

FIG. 9 is an explanatory diagram (Part II) of the sectional areas that are determined as the correction area 2. FIG. 10 is an explanatory diagram (Part III) of the sectional areas that are determined as the correction area 2. FIG. 10 depicts the next state of that in FIG. 9. FIG. 11 is an explanatory diagram (Part IV) of the sectional areas that are determined as the correction area 2. FIG. 11 depicts the next state of that in FIG. 10. FIG. 12 is an explanatory diagram (Part V) of the sectional areas that are determined as the correction area 2. FIG. 12 depicts the next state of that in FIG. 11. FIG. 13 is an explanatory diagram (Part VI) of the sectional areas that are determined as the correction area 2. FIG. 13 depicts the final result of the continuation of the execution of the determination function (Part II) of the correction area 2. Thus, pinpoint designation is enabled for the sectional areas that are suitable for being the RC extraction area. Consequently, the accuracy of the RC extraction can be improved while suppressing increases in the RC extraction area.

Reference of the description returns to FIG. 3. The determination function for the correction area 3 will be described. The detecting unit 304 detects specific sectional areas whose adjacent sectional areas are outside the design change area, that are not determined as the first area for extraction, and that are in the design change area. For example, detecting unit 304 detects the sectional areas that are each adjacent to sectional areas outside the design change area and that are in the design change area. The detected sectional areas are each referred to as a “specific sectional area”.

The detecting unit 304 detects specific adjacent sectional areas that are outside the design change area, that are not determined as the first area for extraction, and that are adjacent to the specific sectional areas. For example, the detecting unit 304 detects the sectional areas that are outside the design change area, that are not determined as the correction area 1, and that are adjacent to the specific sectional areas. The detected sectional areas are each referred to as a “specific adjacent sectional area”. The direction from the position at which the specific sectional area is disposed to the position at which the specific adjacent sectional area is disposed is referred to as “arrangement direction”.

The determining unit 307 determines, as a third area for extraction for the wiring parasitic capacitance, one or more sectional areas including at least the specific adjacent sectional area from among specific sectional areas along the arrangement direction from the specific sectional area detected by the detecting unit 304 to the specific adjacent sectional area. For example, the determining unit 307 determines the one or more sectional areas including at least the specific adjacent sectional area from the specific sectional area along the arrangement direction, as the sectional areas of the correction area 3. For example, an arrangement count of one or more sectional areas that include at least the specific adjacent sectional area from among the specific sectional areas along the arrangement direction is set by the setting unit 308.

The setting unit 308 sets the number of arranged sectional areas of the third area for extraction along the arrangement direction based on the ratio of the area of the wires on the design area to the area of the design area. For example, the setting unit 308 acquires N of Eq. (1) above, that is N=β(Wa/Fa). “Wa” is the total area of the mounted wires. For simplification, Wa may be the value acquired by multiplying the number of sectional areas whose mounting information of the sectional area information store wires, by the area of the sectional areas. “Fa” is the value acquired by multiplying the division number A by the area of the sectional area. Thus, the determining unit 307 can determine N sectional areas including at least the specific adjacent sectional area from among the specific sectional areas along the arrangement direction, as the sectional areas of the correction area 3.

As described, as depicted in FIG. 1, the correction area 3 along the arrangement direction is acquired. Therefore, the accuracy of the RC extraction can be improve while suppressing increases in the RC extraction area taking into consideration the wiring density and the wire width in the sectional areas that are unknown based only on the degree of concentration in the design change area taken into consideration for the correction areas 1 and 2.

Reference of the description returns to FIG. 3. The changing unit 309 changes the positions of the sectional areas in the design change area, and the area for extraction, to positions for which the starting position of the reading by the storage device 202 is closer. For example, the changing unit 309 changes the positions of the sectional areas in the design change area and the sectional areas in the correction areas 1 to 3 to the positions for which the starting position of the reading by the storage device 202 becomes closer. In the example, the “starting position of the reading by the storing unit 202” is set to be the origin O. Therefore, the changing unit 309 causes the RC extraction area formed by the sectional areas in the design change area and the sectional areas in the correction areas 1 to 3, to translate in parallel toward the origin O.

FIG. 14 is an explanatory diagram of an example of the RC extraction area. The RC extraction area of FIG. 14 is an area formed by consolidating the design change area and the correction areas 1 to 3 depicted in FIG. 1.

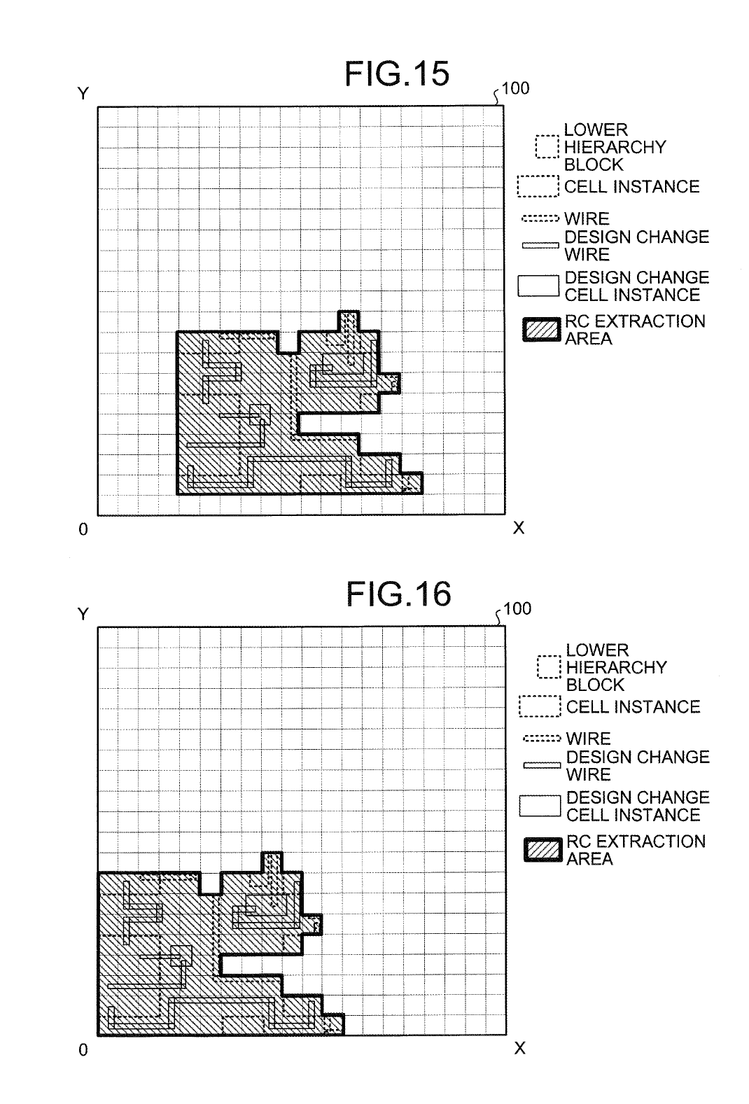

FIG. 15 is an explanatory diagram of an example where information unrelated to the RC extraction area is deleted. FIG. 15 depicts the next state of that in FIG. 14. The deletion of the information that is unrelated the RC extraction area, from the layout data 100 by the changing unit 309 enables the amount of memory used to be reduced.

FIG. 16 is an explanatory diagram of the state after the translation of the RC extraction area by the changing unit 309. FIG. 16 depicts the next state of that in FIG. 15. The changing unit 309 causes the RC extraction area to translate in parallel such that the string of sectional areas on the leftmost edge of the RC extraction area overlaps with the Y-axis and the string of sectional areas on the lowermost edge of the RC extraction area overlaps with the X-axis.

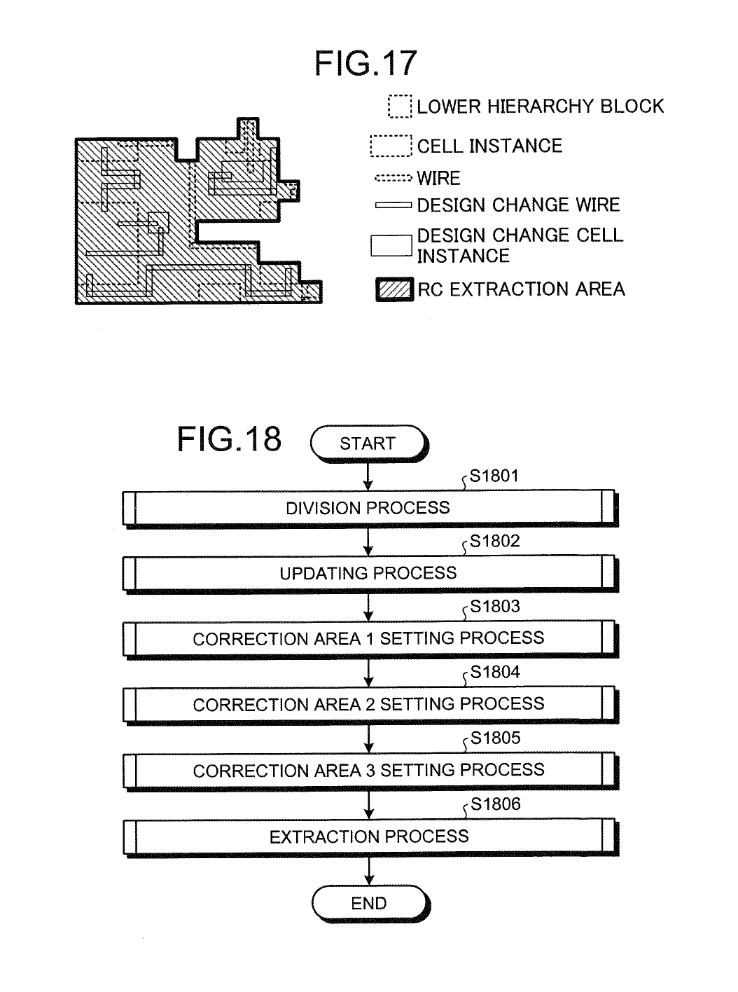

FIG. 17 is an explanatory diagram of a virtual hierarchy to be the RC extraction area acquired after the translation. FIG. 17 depicts the next state of that in FIG. 16. As depicted in FIG. 17, a state is produced virtually where only the RC extraction area is disposed and wired on a single level in the hierarchy. This state is referred to as “virtual hierarchy”. The production of the virtual hierarchy enables reduction of the amount of used memory because a table to retain the data necessary for the RC extraction is only the RC extraction area.

Reference of the description returns to FIG. 3. The extracting unit 310 extracts the RC extraction area from the layout data 100. For example, the extracting unit 310 reads the RC extraction area stored in the storage device 202. The RC extraction is executed for the read RC extraction area and, based on the result thereof, the timing analysis is again executed.

In the above, an example has been described where the layout data 100 is divided using the calculating unit 301 and the dividing unit 302. However, the determining apparatus 200 may be configured without the calculating unit 301. In this case, the division number A is stored in advance in the storage device 202. The determining apparatus 200 may also be configured without the dividing unit 302. In this case, the layout data 100 divided based on the division number A is stored in the storage device 202. Configuration may be such that the determining unit 307 does not execute the processes using the units from the detecting unit 304 to the judging unit 306, that is, does not determine the correction areas 1 to 3 and may determine the design change area as the RC extraction area for the layout data 100 divided based on the division number A.

FIG. 18 is a flowchart of an example of a procedure of a determining process for determining the RC extraction area and executed by the determining apparatus 200. The determining apparatus 200 executes a division process using the calculating unit 301 and the dividing unit 302 (step S1801) and executes an updating process (step S1802), a correction area 1 setting process (step S1803), a correction area 2 setting process (step S1804), a correction area 3 setting process (step S1805), and finally an extraction process using the changing unit 309 and the extracting unit 310 (step S1806).

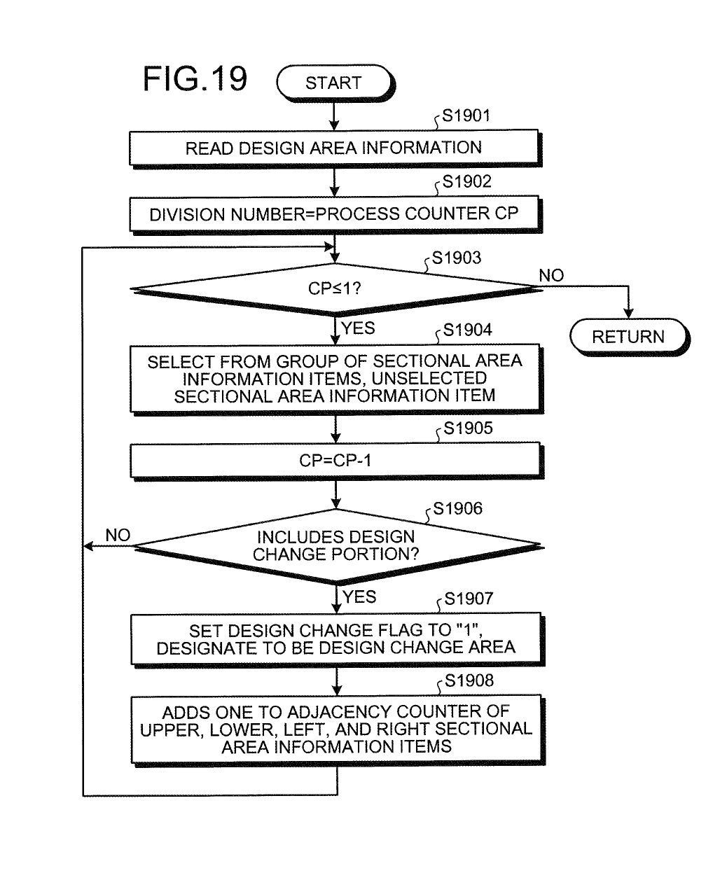

FIG. 19 is a flowchart of an example of a detailed procedure of the updating process (step S1802) depicted in FIG. 18. The determining apparatus 200 reads the design area information (step S1901), sets the division number A in a process counter CP (step S1902), and determines whether the process counter CP is CP≦1 (step S1903). If the determining apparatus 200 determines that the process counter CP is CP≦1 (step S1903: YES), the determining apparatus 200 selects an unselected sectional area information item from the group of sectional area information items (step S1904) and decrements the CP to reduce the process counter by the amount of the sectional area information items selected (step S1905).

Thereafter, the determining apparatus 200 refers to the mounting information of the selected sectional area information item and determines whether the sectional areas identified based on the selected sectional area information item (hereinafter, each referred to as “selected sectional area”) includes any design change portion such as a design change wire, a design change cell instance, or a design change via hole (step S1906). If the determining apparatus 200 determines that the selected sectional areas include no design change portion (step S1906: NO), the procedure returns to step S1903.

On the other hand, if the determining apparatus 200 determines that the selected sectional areas include design change portions (step S1906: YES), the determining apparatus 200 designates the selected sectional areas to be the design change area by setting the design change flag of each of the selected sectional area information items, to be “1” (step S1907), calls the sectional area information items of the sectional areas immediately above and beneath, and on the right and the left of each of the selected sectional areas that are designated to be the design change area, and adds one to the adjacency counter of each of the called sectional area information items (step S1908) and the procedure returns to step S1903.

If the determining apparatus 200 determines at step S1903 that the process counter CP is not CP≦1 (step S1903: NO), the updating process (step S1802) comes to an end and the correction area 1 setting process (step S1803) is executed.

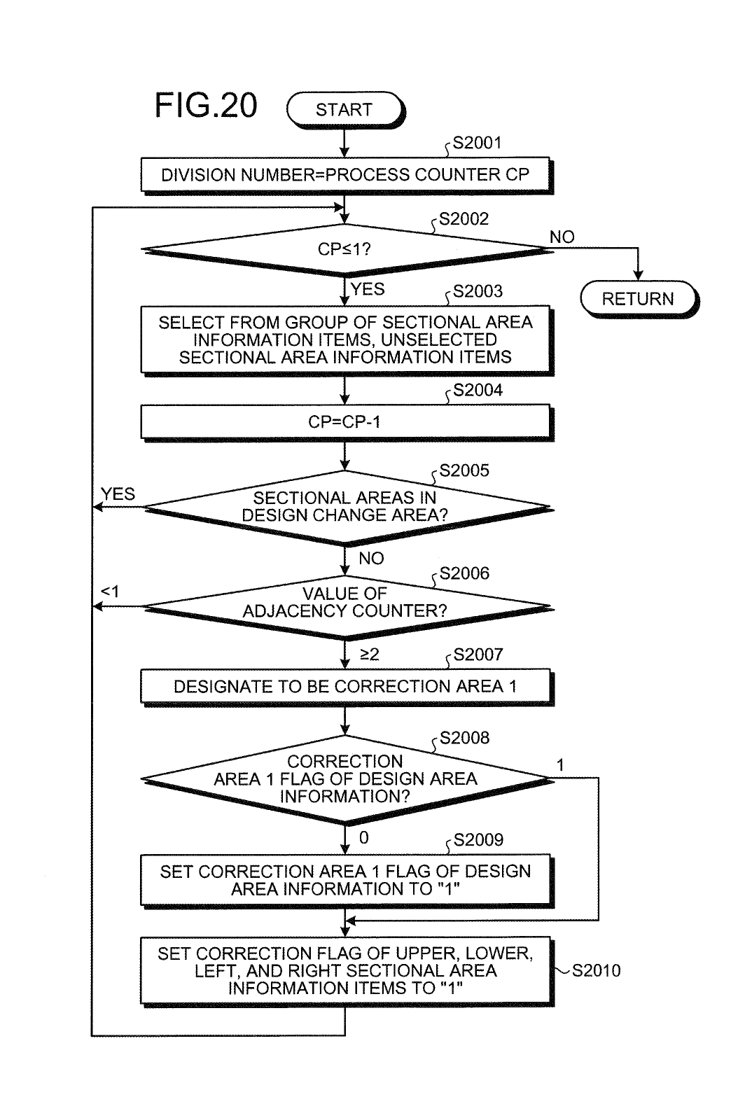

FIG. 20 is a flowchart of an example of a detailed process procedure of the correction area 1 setting process (step S1803) depicted in FIG. 18. The determining apparatus 200 sets the division number A in the process counter CP (step S2001), and determines whether CP≦1 (step S2002). If the determining apparatus 200 determines that the process counter CP is CP≦1 (step S2002: YES), the determining apparatus 200 selects unselected sectional area information items from the group of sectional area information items (step S2003) and decrements the CP to reduce the process counter by the number of the sectional area information items selected (step S2004).

Thereafter, the determining apparatus 200 refers to the design change flag of each of the selected sectional area information items and determines whether the selected sectional areas are sectional areas in the design change area (step S2005). If the determining apparatus 200 determines that the selected sectional areas are the sectional areas in the design change area (step S2005: YES), the sectional areas are excluded from the correction area 1 and therefore, the procedure returns to step S2002. On the other hand, if the determining apparatus 200 determines that the selected sectional areas are not the sectional areas in the design change area (step S2005: NO), the determining apparatus 200 checks the value of the adjacency counter (step S2006).

If the determining apparatus 200 determines that the value of the adjacency counter is less than or equal to one (step S2006: <1), these sectional areas are excluded from the correction area 1 and therefore, the procedure returns to step S2002. On the other hand, when the determining apparatus 200 determines that the value of the adjacency counter is greater than or equal to two (step S2006: ≧2), the determining apparatus 200 designates the selected sectional areas to be the correction area 1 (step S2007). For example, the determining apparatus 200 sets the correction area 1 flag of the sectional area information items of each of the selected sectional areas to be “1”.

The determining apparatus 200 checks the correction area 1 flag of the design area information (step S2008). If the determining apparatus 200 determines that the correction area 1 flag is “1” (step S2008: 1), the procedure advances to step S2010. On the other hand, if the determining apparatus 200 determines that the correction area 1 flag is “0” (step S2008: 0), the determining apparatus 200 sets the correction area 1 flag of the design area information to be “1” (step S2009) and the procedure advances to step S2010. Thereafter, the determining apparatus 200 calls the sectional area information items of the sectional areas immediately above and beneath, and on the right and left of each of the selected sectional areas that are designated to be the correction area 1, and sets the correction flag of each of the called sectional area information items to be “1” (step S2010) and the procedure returns to step S2002.

If the determining apparatus 200 determines at step S2002 that the process counter CP is not CP≦1 (step S2002: NO), the correction area 1 setting process (step S1803) comes to an end and the correction area 2 setting process (step S1804) is executed.

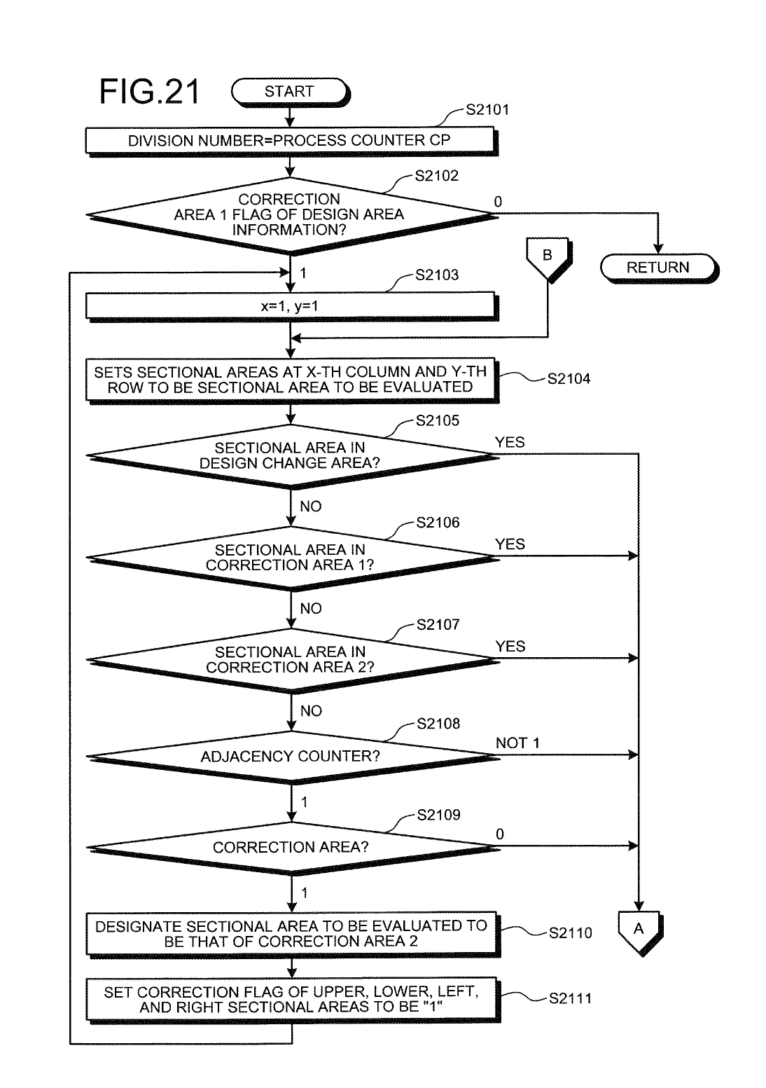

FIG. 21 is a flowchart (Part I) of an example of a detailed process procedure of the correction area 2 setting process (step S1804) depicted in FIG. 18. The determining apparatus 200 sets the division number A in the process counter CP (step S2101) and checks the correction area 1 flag of the design area information (step S2102). If the determining apparatus 200 determines that the correction area 1 flag indicates “0” (step S2102: 0), the correction area 2 can not be set and therefore, the procedure advances to the correction area 3 setting process (step S1805).

On the other hand, if the determining apparatus 200 determines that the correction area 1 flag indicates “1” (step S2102: 1), sectional areas designated to be the correction area 1 are present and therefore, the determining apparatus 200 sets x and y to be x=1 and y=1 (step S2103) and sets the sectional areas at the x-th column and y-th row to be a sectional area to be evaluated (step S2104). The “sectional area to be evaluated” is the sectional area whose X-coordinate value is x and whose Y-coordinate value is y.

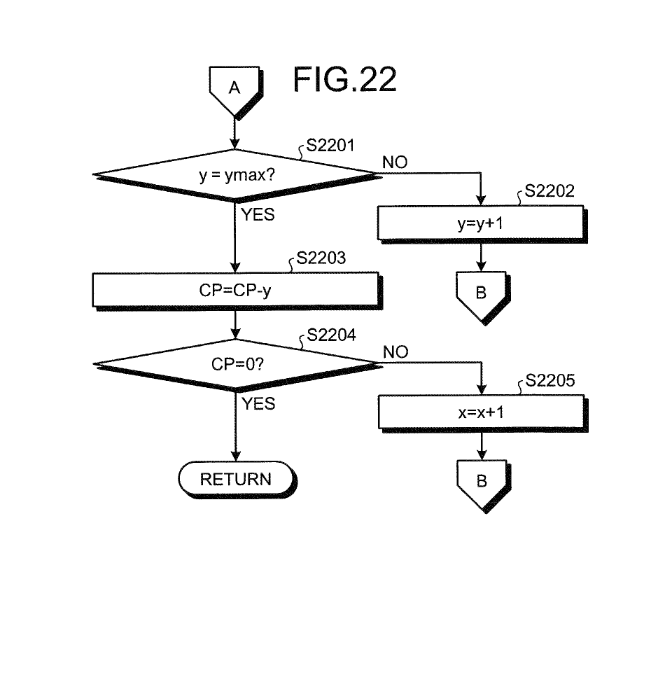

The determining apparatus 200 refers to the design change flag of the sectional area information of the sectional area to be evaluated and determines whether the sectional area to be evaluated is the sectional area in the design change area (step S2105). If the determining apparatus 200 determines that the sectional area is the sectional area in the design change area (step S2105: YES), the procedure advances to step S2201 of FIG. 22. Thus, the sectional areas in the design change area can be excluded from the correction area 2.

On the other hand, if the determining apparatus 200 determines that the sectional area is not the sectional area in the design change area (step S2105: NO), the determining apparatus 200 refers to the correction area 1 flag of the sectional area information of the sectional area to be evaluated and determines whether the sectional area to be evaluated is a sectional area in the correction area 1 (step S2106). If the determining apparatus 200 determines that the sectional area is a sectional area in the correction area 1 (step S2106: YES), the procedure advances to step S2201 of FIG. 22. Thus, the sectional area of the correction area 1 can be excluded from the correction area 2.

On the other hand, if the determining apparatus 200 determines that the sectional area is not a sectional area in the correction area 1 (step S2106: NO), the determining apparatus 200 refers to the correction area 2 flag of the sectional area information of the sectional area to be evaluated and determines whether the sectional area to be evaluated is a sectional area in the correction area 2 (step S2107). If the determining apparatus 200 determines that the sectional area to be evaluated is a sectional area in the correction area 2 (step S2107: YES), the procedure advances to step S2201 of FIG. 22. Thus, the sectional area already designated to be that of the correction area 2 can be excluded from the correction area 2.

On the other hand, if the determining apparatus 200 determines that the sectional area to be evaluated is not a sectional area in the correction area (step S2107: NO), the determining apparatus 200 checks the adjacency counter of the sectional area information of the sectional area to be evaluated (step S2108). If the determining apparatus 200 determines that the value of the adjacency counter is a value other than “one” (step S2108: NOT 1), the procedure advances to step S2201 of FIG. 22. Thereby, a sectional area other than the sectional area in contact with the design change area at only one side can be excluded.

On the other hand, if the determining apparatus 200 determines that the value of the adjacency counter is “one” (step S2108: 1), the determining apparatus 200 checks the correction flag of the sectional area information of the sectional area to be evaluated (step S2109). If the determining apparatus 200 determines that the correction flag indicates “0” (step S2109: 0), the procedure advances to step S2201 of FIG. 22. Thus, a sectional area that is in contact with the design change area at one side and that is not in contact with the correction area 1 can be excluded.

On the other hand, if the determining apparatus 200 determines that the value of the correction flag is “1” (step S2109: 1), the sectional area is in contact with the design change area through at one side and is also in contact with the correction area 1 or 2 at another one side and therefore, the determining apparatus 200 designates the sectional area to be evaluated to be that of the correction area 2 (step S2110). For example, the determining apparatus 200 sets the correction area 2 flag of the sectional area information of the sectional area evaluated to be “1”. The determining apparatus 200 sets the correction flag to be “1” for the sectional area information of each of the sectional areas immediately above and beneath and on the right and the left of the sectional area evaluated (step S2111) and the procedure returns to step S2103.

FIG. 22 is a flowchart (Part II) of an example of a detailed process procedure of the correction area 2 setting process (step S1804) depicted in FIG. 18. The determining apparatus 200 determines whether the Y-coordinate value y of the sectional area to be evaluated is y=ymax (step S2201). “ymax” is the maximal value of the Y-coordinate value of the sectional area to be evaluated. If the determining apparatus 200 determines that the Y-coordinate value y is not y=ymax (step S2201: NO), the determining apparatus 200 increments y and advances to the next y row (step S2202) and the procedure returns to step S2104 of FIG. 21.

On the other hand, if the determining apparatus 200 determines that the Y-coordinate value y is y=ymax (step S2201: YES), the determining apparatus 200 decrements CP by the amount corresponding to y (step S2203) and determines whether the CP after the decrementing is CP=0 (step S2204). If the determining apparatus 200 determines that the CP after the decrementing is not CP=0 (step S2204: NO), the determining apparatus 200 increments x and advances to the next x column (step S2205) and the procedure returns to step S2104 of FIG. 21. On the other hand, if the determining apparatus 200 determines that the CP after the decrementing is CP=0 (step S2204: YES), the correction area 2 setting process (step S1804) comes to an end and the correction area 3 setting process (step S1805) is executed.

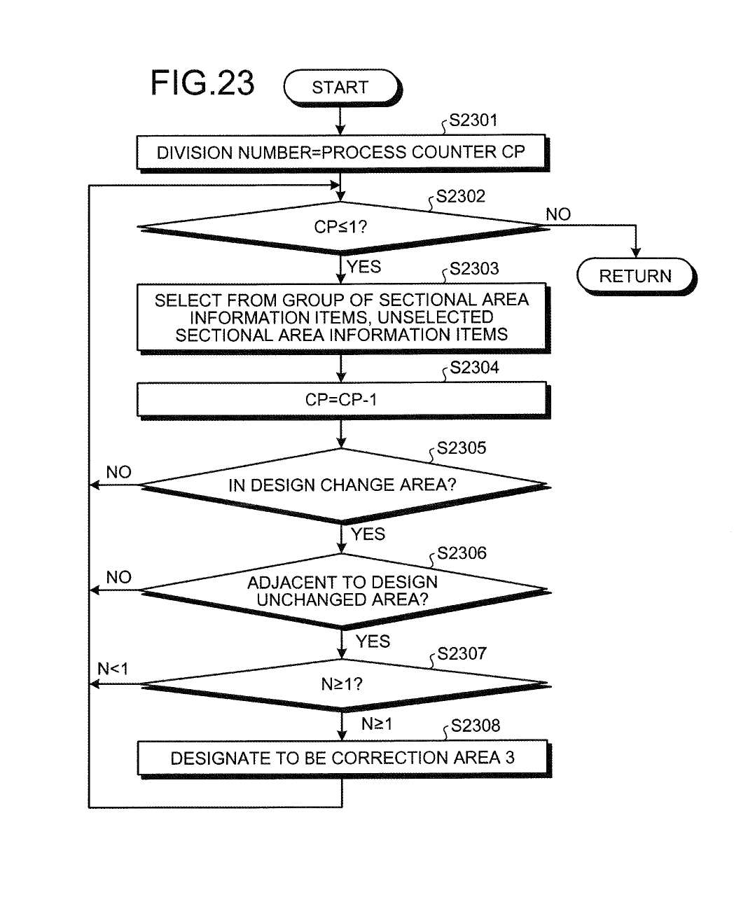

FIG. 23 is a flowchart of an example of a detailed process procedure of the correction area 3 setting process (step S1805) depicted in FIG. 18. The determining apparatus 200 sets the division number A in the process counter CP (step S2301) and determines whether the CP is CP≦1 (step S2302). If the determining apparatus 200 determines that the CP is CP≦1 (step S2302: YES), the determining apparatus 200 selects unselected sectional area information items from the group of sectional area information items (step S2303) and decrements the CP to reduce the process counter by the number corresponding to the number of sectional area information items selected (step S2304).

Thereafter, the determining apparatus 200 refers to the design change flag of the selected sectional area information and determines whether the selected sectional area is a sectional area in the design change area (step S2305). If the determining apparatus 200 determines that the selected sectional area is not a sectional areas in the design change area (step S2305: NO), the sectional area is excluded from the correction area 3 and therefore, the procedure returns to step S2302. On the other hand, if the determining apparatus 200 determines that the selected sectional area is a sectional area in the design change area (step S2305: YES), the determining apparatus 200 determines whether the selected sectional area is adjacent to a design unchanged area (step S2306). If the determining apparatus 200 determines that the selected sectional area is not adjacent to a design unchanged area (step S2306: NO), the procedure returns to step S2302.

On the other hand, if the determining apparatus 200 determines that the selected sectional area is adjacent to a design unchanged area (step S2306: YES), the selected sectional area is a sectional area that is in the design change area and that is adjacent to the exterior of the design change area and therefore, the determining apparatus 200 acquires N using Eq. (1) and determines whether N is N≧1 (step S2307). If the determining apparatus 200 determines that N is N<1 (step S2307: N<1), the procedure returns to step S2302. On the other hand, if the determining apparatus 200 determines that N is N≧1 (step S2307: N≧1), the determining apparatus 200 designates N sectional areas disposed from the selected sectional area in the arrangement direction to be the correction area 3 (step S2308). For example, the determining apparatus 200 calls the N sectional area information items of the N sectional areas disposed from the selected sectional area in the arrangement direction and sets the correction area 3 flag of each of the N sectional area information items to be “1” and the procedure returns to step S2303.

If the determining apparatus 200 determines at step S2302 that the CP is not CP≦1 (step S2302: NO), the correction area 3 setting process (step S1805) comes to an end and the extraction process (step S1806) is executed.

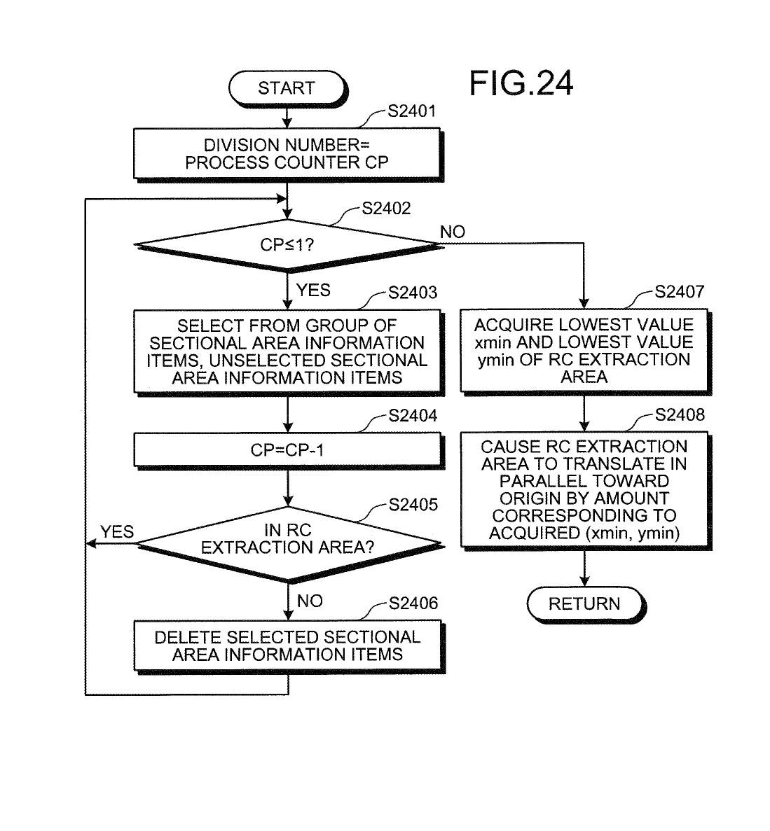

FIG. 24 is a flowchart of an example of a detailed process procedure of the extraction process (step S1806) depicted in FIG. 18. The determining apparatus 200 sets the division number A in the process counter CP (step S2401) and determines whether CP is CP≦1 (step S2402). If the determining apparatus 200 determines that CP is CP≦1 (step S2402: YES), the determining apparatus 200 selects unselected sectional area information items from the group of sectional area information items (step S2403) and decrements the CP by the number corresponding to the number of sectional area information items selected to reduce the process counter (step S2404).

Thereafter, the determining apparatus 200 refers to the design change flag, the correction area 1 flag, the correction area 2 flag, and the correction area 3 flag of each of the sectional area information items selected and determines whether the selected sectional areas are sectional areas in the RC extraction area (step S2405). If the determining apparatus 200 determines that the selected sectional areas are sectional areas in the RC extraction area (step S2405: YES), the selected sectional areas are not to be deleted and the procedure returns to step S2402. On the other hand, if the determining apparatus 200 determines that the selected sectional areas are not sectional areas in the RC extraction area (step S2405: NO), the determining apparatus 200 deletes the selected sectional area information items (step S2406) and the procedure returns to step S2402.

If the determining apparatus 200 determines at step S2402 that CP is not CP≦1 (step S2402: NO), the determining apparatus 200 refers to the group of sectional area information items that remain and acquires the lowest value xmin among the X-coordinate values and the lowest value ymin among the Y-coordinate values of the RC extraction area (step S2407) and causes the RC extraction area to translate in parallel toward the origin by the amount corresponding to the acquired (xmin, ymin) (step S2408). Thus, the extraction process (step S1806) comes to an end.

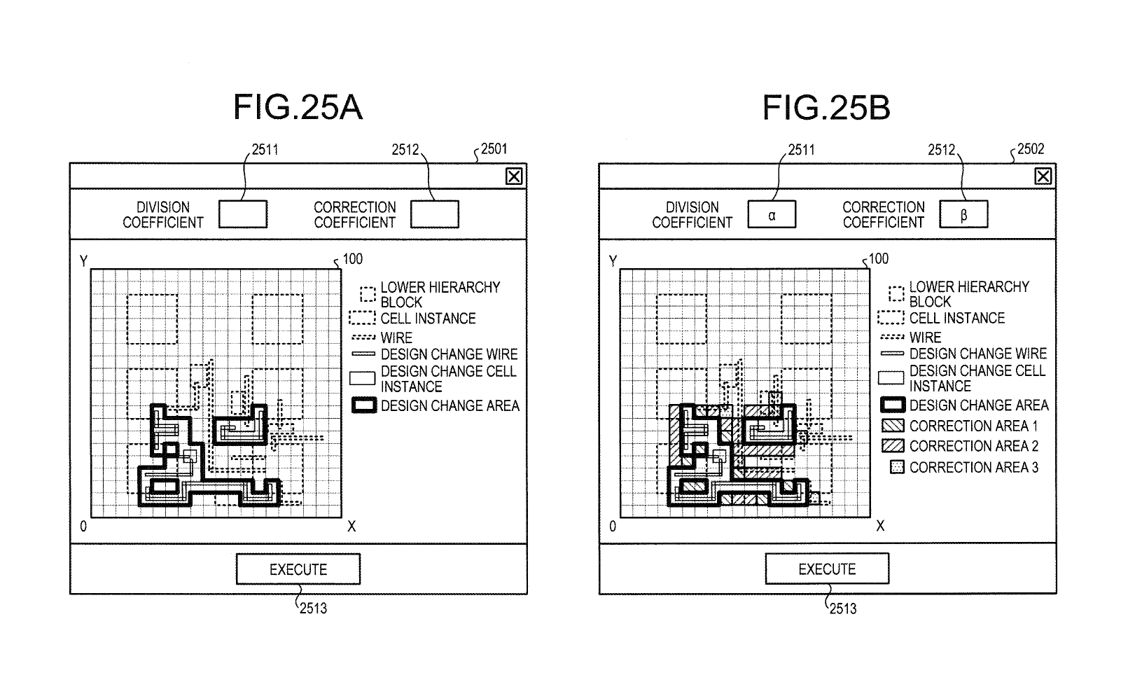

FIGS. 25A and 25B are explanatory diagrams of examples of an input and output screen on the determining apparatus 200 according to the embodiment. FIG. 25A depicts a screen 2501 displayed before the execution of the determination process acquired after the design change and FIG. 25B depicts a screen 2502 displayed after the execution of the determination process. In FIG. 25A, the layout data 100 depicted in FIG. 6 is displayed. In FIG. 25A, the values of α and β are input respectively into an input columns 2511 and 2512 of the division coefficient and the correction coefficient. An execution button 2513 is clicked, whereby the determining process is executed and the screen 2501 transitions to the screen 2502 in the state depicted in FIG. 25B. On the screen 2502, the layout data 100 acquired after the execution as depicted in FIG. 1 is displayed.

As described, according to the embodiment, the processing time period for the RC extraction can be reduced with a range that the accuracy necessary for the timing analysis can be maintained. In particular, setting the correction area 1 enables the accuracy of the RC extraction to be improved while suppressing increases in the RC extraction area.

According to the embodiment, setting the correction area 2 enables pinpoint designation of the sectional area suitable for the RC extraction area and consequently, the accuracy of the RC extraction can be improves while suppressing increases in the RC extraction area.

According to the embodiment, setting the correction area 3 enables the accuracy of the RC extraction to be improved while suppressing increases in the RC extraction area, taking into consideration the wiring density and the wire width in the sectional areas that are unknown based only on the degree of concentration in the design change area taken into consideration for the correction areas 1 and 2.

According to the embodiment, deletion the information unrelated to the RC extraction area enables the amount of memory used to be reduced. Causing the RC extraction area to translate to a position close to the origin O enables the efficiency of memory access to be improved and consequently, improved processing speed can be facilitated.

According to an aspect of the embodiments, an effect is achieved in that the processing time period of the RC extraction can be reduced to the extent that the accuracy necessary for the timing analysis can be maintained.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A determining apparatus comprising
a processor configured to:
detect from among a group of sectional areas obtained by dividing layout data indicating a design area concerning a circuit-under-design and stored in a storage device, adjacent sectional areas that are adjacent to sectional areas in a design change area and outside the design change area;
count with respect to the sectional areas that are outside the design change area and among the group of sectional areas, number of detections as the adjacent sectional area;
judge whether the number of detections counted is at least a predetermined number of two; and
determine as an area for extraction for wiring parasitic capacitance, the sectional areas for which the number of detections is judged to be at least the predetermined number.

2. The determining apparatus according to claim 1, wherein
the processor detects from among the group of sectional areas, the adjacent sectional areas that are adjacent to the sectional areas in the design change area and to the sectional areas determined as the area for extraction and referred to as a first area for extraction, that are not determined as the first area for extraction, and that are outside the design change area, and
the processor determines as a second area for extraction for the wiring parasitic capacitance, the adjacent sectional areas that are detected, that are adjacent to the sectional areas in the design change area and the sectional areas determined as the first area for extraction, that are not determined as the first area for extraction, and that are outside the design change area.

3. The determining apparatus according to claim 2, wherein
the processor detects from among the group of sectional areas, the adjacent sectional areas that are adjacent to the sectional areas in the design change area and to the sectional areas determined as the second area for extraction, that are not determined as the first or the second area for extraction, and that are outside the design change area, and
the processor determines the adjacent sectional areas that are detected, that are adjacent to the sectional areas in the design change area and the sectional areas determined as the second area for extraction, that are not determined as the second area for extraction, and that are outside the design change area, as the second area for extraction.

4. The determining apparatus according to claim 1, wherein
the processor detects specific sectional areas that have adjacent sectional areas outside the design change area, that are not determined as the area for extraction, which is referred to as a first area for extraction, and that are in the design change area, and also detects specific adjacent sectional areas that are outside the design change area, that are not determined as the first area for extraction, and that are adjacent to the specific sectional areas, and
the processor determines one or more sectional areas from among the specific sectional areas having at least the specific adjacent sectional area along an arrangement direction from the specific sectional area to the specific adjacent sectional area detected by the detecting unit, as a third area for extraction for the wiring parasitic capacitance.

5. The determining apparatus according to claim 4, the processor further configured to
set number of arranged sectional areas of the third area for extraction along the arrangement direction based on a ratio of an area of wires in the design area to an area of the design area, wherein
the processor determines the sectional areas of the number set from the specific sectional areas along the arrangement direction, as the third area for extraction.

6. The determining apparatus according to claim 1, the processor further configured to
change positions of the sectional areas in the design change area and of the area for extraction to positions by which a starting position of reading by the storage device becomes closer.

7. The determining apparatus according to claim 1, the processor further configured to:
calculate a division number for the design area based on an area of mounted components mounted in the design area; and
divide the design area based on the division number, wherein
the processor detects from among a group of sectional areas divided from layout data indicating the design area, adjacent sectional areas that are adjacent to the sectional areas in the design change area and that are outside the design change area.

8. A determining apparatus comprising
a processor configured to
calculate a division number for a design area based on an area of mounted components mounted in the design area;
divide layout data indicating the design area, based on the division number; and
determine from a among group of sectional areas divided from the layout data indicating the design area, a sectional area in a design change area as an area for extraction for wiring parasitic capacitance.

9. A determining method executed by a computer, the determining method comprising:
detecting from among a group of sectional areas obtained by dividing layout data indicating a design area concerning a circuit-under-design and stored in a storage device, adjacent sectional areas that are adjacent to sectional areas in a design change area and outside the design change area;
counting with respect to the sectional areas that are outside the design change area and among the group of sectional areas, number of detections as the adjacent sectional area;
judging whether the number of detections counted is at least a predetermined number of two; and
determining as an area for extraction for wiring parasitic capacitance, the sectional areas for which the number of detections is judged to be at least the predetermined number.

10. A computer-readable recording medium storing a determining program causing a computer to execute a process comprising:
detecting from among a group of sectional areas obtained by dividing layout data indicating a design area concerning a circuit-under-design and stored in a storage device, adjacent sectional areas that are adjacent to sectional areas in a design change area and outside the design change area;
counting with respect to the sectional areas that are outside the design change area and among the group of sectional areas, number of detections as the adjacent sectional area;
judging whether the number of detections counted is at least a predetermined number of two; and
determining as an area for extraction for wiring parasitic capacitance, the sectional areas for which the number of detections is judged to be at least the predetermined number.
